(19) United States
(12) Patent Application Publication
(10) Pub. No.: US 2003/0040435 A1
(43) Pub. Date: Feb. 27, 2003

(54) Slow-release fertilizers and method for production of same

(76) Inventors: Karl Haberle, Speyer (DE); Matthias Raedle, Weisenheim/Berg (DE); Udo Geiger, Hessheim (DE); Klaus Horchler, Limburgerhof (DE); Alexander Wissemeier, Speyer (DE); Reinhardt Hahndel, Limburgerhof (DE); Simone Willkommen, Worms (DE)

Correspondence Address: COLLARD & ROE, P.C., 1077 Northern Boulevard, Roslyn, NY, 11576-1696, US

(21) Appl. No.: 10/161,847

(22) Filed: Jun. 4, 2002

(30) Foreign Application Priority Data
Jun. 5, 2001 (DE) 101 27 206.5

(51) Int. Cl. C05G 3/00

(52) U.S. Cl. 504/101

(57) ABSTRACT

A method is for production of solid agents that contain nutrients for plants, that are coated with at least one biodegradable layer and that are produced by using dispersions containing polymers carrying urethane and urea groups for surface treatment of solid agents containing nutrients for plants.

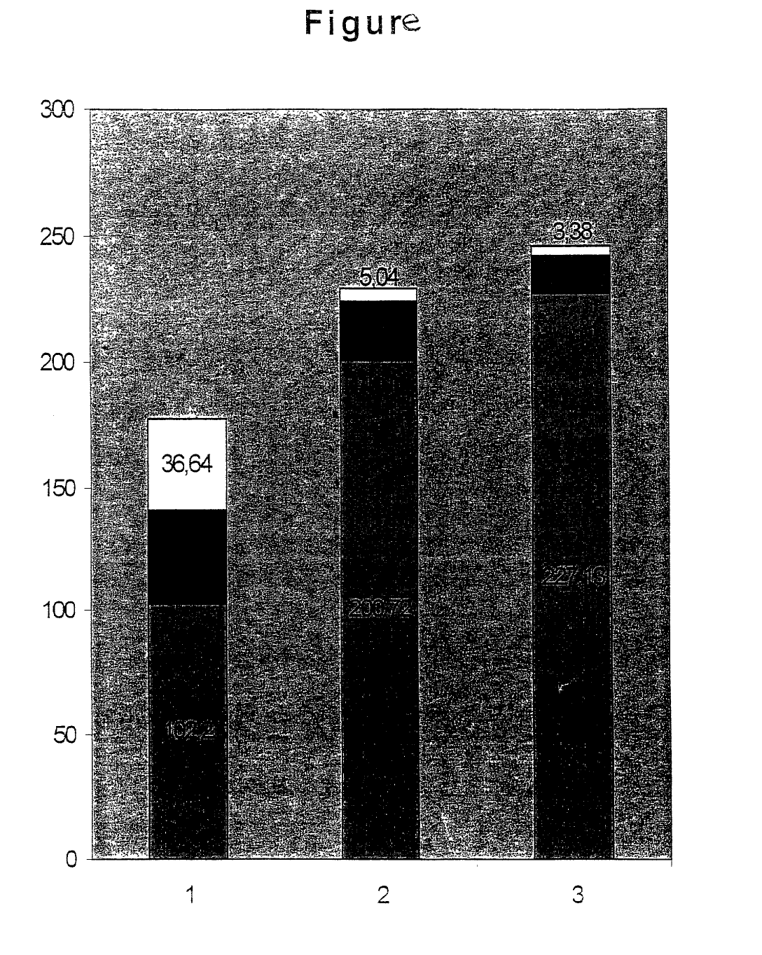

### BACKGROUND OF THE INVENTION

1. Field of the Invention

The present invention relates to a method for production of a solid agent that contains nutrients for plants and that is enveloped in a biodegradable coating, to agents produced by this method and to use of such agents.

2. The Prior Art

It is generally known that fertilizer granules coated with a polymer layer can be used as fertilizers. The efficiency of such fertilizers is improved by the coating, because the coated fertilizer releases the substances functioning as plant nutrients gradually over time and thus can develop its action over a prolonged period. Such slow-release fertilizers are described in, for example, Ullmann's Encyclopedia of Industrial Chemistry, 5th Edition, 1987, Vol. A10, pp. 363 to 369, and their advantages are summarized in Fert. Res. 1993, Vol. 35, pp. 1 to 12.

Numerous fertilizers in the form of granules coated with biodegradable polymers have been described in the past.

For example, International Patent WO 95/03260 relates to a fertilizer with a coating comprising two layers. This fertilizer, which can be used both in agriculture and hydroculture, contains an inner biodegradable layer composed of an aliphatic polyester and/or polyurethane and a water-insoluble outer layer containing slowly biodegradable polymers, such as biodegradable cellulose derivatives, low molecular weight polyethylene, low molecular weight wax and low molecular weight paraffin or a photodegradable resin. The polymers used as the outer layer as described therein, however, usually have stickiness that cannot be disregarded and that constitutes a disadvantage in the use of these coated fertilizers.

Japanese Patent 07-309689 relates to a fertilizer provided with a coating made mainly from a lactic acid polyester. Therein it is specified that, in particular, there is used a lactic acid copolymer composed of lactic acid, a dicarboxylic acid and a diol, preferably of lactic acid, an aliphatic dicarboxylic acid, an aromatic dicarboxylic acid and a diol. In the description it is specified that the content of lactic acid in the copolymer used therein is at least 50 wt %.

Further fertilizers coated with biodegradable polymers are described in Japanese Patent Applications 08-2989, 07-315976, 08-26875, 07-33577 and 05-97561, in which aliphatic polyesters, poly(hydroxycarboxylic acids), cellulose and polymers having one of these components as the main component are used as the coating.

Coated fertilizer granules in which the coating is an ethylene copolymer carrying carboxyl groups are described in European Patent EP 832053 B1.

EP 931036 B1 describes the coating of fertilizer granules with dispersions of polyesters. The chains of these polyesters can also be lengthened with isocyanates, and so the dispersions are more accurately described as polyester-urethane dispersions.

The coated fertilizers described in the prior art suffer from an entire series of disadvantages, and in some cases considerable technological difficulties are encountered in their processing.

For example, some coating materials described in the prior art are relatively sticky at elevated temperature. Since many of the polymers used are applied as aqueous dispersions, even though the fertilizer granules are readily soluble in water, the water must be removed as rapidly as possible. In many cases, however, the stickiness of the polymers makes it impossible to reach the high process temperature that would be desirable for this purpose, and so plant capacity remains subject to narrow limits.

The considerable surface stickiness of the polymer-coated fertilizers is also a disadvantage as regards storage of the unprotected polymer-coated product at room temperature. Furthermore, coated fertilizers must be able to withstand the mechanical stresses and strains to which they may be exposed during use. The coating envelopes must not be damaged by such effects, since otherwise they would lose their efficacy under certain circumstances.

### SUMMARY OF THE INVENTION

It is an object of the present invention therefore to provide a method with which it is possible to produce agents that contain plant nutrients, preferably fertilizers in the form of granules coated with at least one biodegradable polymer layer, and that no longer suffer from the cited disadvantages of the prior art. A particular object of the invention is to provide polymers that can be applied without the use of organic solvents. At the same time, the coated fertilizers must have adequate long-time effect and must guarantee slow release of the nutrients. Furthermore, the quantity of polymer needed for coating in order to achieve an adequate slow-release effect must be as small as possible. In particular, the coated agents must not tend to agglutination, especially at temperatures that normally occur during storage or transportation, if special precautions are not taken in this regard. This means, however, that the coated agents must have practically no stickiness even at temperatures much higher than room temperature (25° C.).

Furthermore, the polymers used for coating must not be too hard or brittle, since otherwise the coating can be damaged or can even burst under the mechanical stresses and strains to which the coated agents are exposed, for example during transfer from one container to another. Finally, the agents must satisfy the increasingly more stringent requirements in terms of simple and economic production capability.

This object is achieved by a method in which at least one polymer layer is formed by applying dispersions containing polymers carrying urethane and urea groups onto the solid agents.

The invention also relates to solid agents that contain plant nutrients, that are coated with a biodegradable polymer layer and that can be produced by the said method.

Accordingly, it is primarily fertilizers that are to be understood by solid agents. According to the invention, however, other active ingredients such as substances with herbicidal, biocidal or fungicidal action can also be used alternatively or additionally.

Accordingly, the use of the coated agents as fertilizers for plants is also subject matter of the invention. According to the invention, mainly polymers dispersed in water are to be understood as dispersions. Specially preferred are aqueous dispersions containing 20 to 90 wt %, preferably 30 to 80 wt % of water and 10 to 80 wt %, preferably 20 to 70 wt % of polymers carrying urethane and urea groups.

Accordingly, it is preferable largely or completely to avoid the use of organic solvents for dispersing the polyurethane, to ensure that problems such as toxicity, disposal and the danger of explosions, which are associated with the use of organic solvents, cannot occur during preparation of the inventive dispersions.

According to the invention, dispersions such as those described on page 2, line 43 to page 5, line 63 of German Patent 19825453 A1 are preferred as dispersions containing polymers carrying urea and urethane groups.

Particularly preferred are inventive polymer dispersions based on polyester polyols and isocyanates. Especially preferred are polymer dispersions based on aliphatic isocyanates. Very special preference is given to anionic polymer dispersions.

Most highly preferred are polyurethane dispersions prepared as follows:

a) an NCO-terminal prepolymer is synthesized from macrools, ionic or potentially ionic polyols and excess polyisocyanates,

b) this prepolymer is reacted with compounds having at least 2 amino groups that are reactive toward isocyanate, in a ratio of NCO groups/NH groups of ≦1:1,

c) then neutralized and

d) dispersed with water.

As macrools there are used such compounds that have a molecular weight of 500 to 5000, preferably 800 to 4500, most preferably 800 to 3000. The use of macrodiols is particularly preferred.

Suitable macrools are in particular polyester polyols, such as are known from Ullmann's Encyclopedia of Industrial Chemistry, 4th Edition, Vol. 19, pp. 62 to 65. Preferably there are used polyester polyols obtained by reaction of dihydric alcohols with dibasic carboxylic acids. Instead of the free polycarboxylic acids there can also be used the corresponding polycarboxylic acid anhydrides or corresponding polycarboxylic acid esters of lower alcohols or mixtures thereof for synthesis of the polyester polyols. The polycarboxylic acids can be aliphatic, cycloaliphatic, araliphatic, aromatic or heterocyclic and if appropriate may be substituted with halogen atoms, for example, and/or may be unsaturated. Examples in this regard include suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic acid anhydride, alkenylsuccinic acid, fumaric acid and dimeric fatty acids. Preferred are dicarboxylic acids of general formula HOOC—(CH₂)_{y}—COOH, where y is a number from 1 to 20, preferably an even number from 2 to 20, examples being succinic acid, adipic acid, dodecanedicarboxylic acid and sebacic acid.

Examples of suitable diols are ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, dipropylene glycol, polypropylene glycol, dibutylene glycol and polybutylene glycols. Preferred are alcohols of general formula HO—(CH₂)ₓ—OH, where x is a number from 1 to 20, preferably an even number from 2 to 20. Examples in this regard are ethylene glycol, butane-1,4-diol, hexane-1,6-diol, octane-1,8-diol and dodecane-1,12-diol. Also preferred are neopentyl glycol and pentane-1,5-diol.

Further possibilities also include polycarbonate diols, such as can be obtained by reacting phosgene with an excess of the low molecular weight alcohols cited as structural components for the polyester polyols.

Also suitable are polyester diols on a lactone basis, represented by homopolymers or copolymers of lactones, preferably by products containing terminal hydroxyl groups and obtained by addition of lactones to suitable difunctional starter molecules. Examples of preferred lactones include such derived from compounds of general formula HO—(CH₂)_{z}—COOH, where z is a number from 1 to 20 and in which an H atom of a methylene unit can also be substituted by a C₁ to C₄ alkyl group. Examples are epsilon-caprolactone, β-propiolactone, γ-butyrolactone and/or methyl-epsilon-caprolactone as well as mixtures thereof. Examples of suitable starter components are the low molecular weight dihydric alcohols cited in the foregoing as structural components for the polyester polyols. The corresponding polymers of ε-caprolactone are particularly preferred. Lower polyester diols of polyether diols can also be used as starters for synthesis of the lactone polymers. Instead of polymers of lactone there can also be used the chemically equivalent polycondensation products of the hydroxycarboxylic acids corresponding to the lactones.

Polyetherols are also suitable as monomers. They can be obtained in particular by homopolymerization of propylene oxide, butylene oxide, tetrahydrofuran, styrene oxide or epichlorohydrin, for example in the presence of BF₃, or by addition of these compounds, in a mixture or successively as the case may be, to starter components containing reactive hydrogen atoms, such as alcohols or amines, examples being water, ethylene glycol, propane-1,2-diol, 1,2-bis(4-hydroxyphenyl)propane or aniline. Particularly preferred is polytetrahydrofuran having a molecular weight of 240 to 5000, and especially 500 to 4500.

Also suitable are polyhydroxyolefins, preferably such with 2 terminal hydroxyl groups, such as α,ω-dihydroxypolybutadiene, α,ω-dihydroxypolymethacrylate esters or α,ω-dihydroxypolyacrylate esters as monomers. Such compounds are known, for example, from European Patent EP A 0622378. Further suitable polyols are polyacetals, polysiloxanes and alkyd resins.

Besides the cited macrools, there can also be added short-chain polyols if necessary. Suitable examples include short-chain diols with a molecular weight of 62 to 500, especially 62 to 200 g/mol.

As short-chain diols there are used, especially as structural components, the short-chain alkanediols cited for the synthesis of polyester polyols, the nonbranched diols with 2 to 12 C atoms and an even number of C atoms, as well as pentane-1,5-diol, being preferred. Other suitable diols are phenols, aromatic dihydroxy compounds or bisphenol A or F.

According to the invention, 2,2-di-(hydroxymethyl)-alkanemonocarboxylic acids with up to 10 carbon atoms in total are suitable as the ionic or potentially ionic polyols. Suitable monomers with (potentially) anionic groups usually include aliphatic, cycloaliphatic, araliphatic or aromatic carboxylic acids and sulfonic acids containing at least one alcoholic hydroxyl group or at least one primary or secondary amino group, especially with 3 to 10 carbon atoms, as also described in U.S. Pat. No. A 3,412,054. In particular, compounds of the general formula

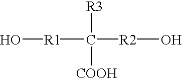

in which R¹ and R² denote a C₁ to C₄ alkanediyl unit and R¹ denotes a C₁ to C₄ alkyl unit are suitable. Dimethylolpropionic acid is particularly preferred.

As polyisocyanates, the diisocyanates usually used in polyurethane chemistry are preferable according to the invention.

Worth particular mention are diisocyanates of formula X(NCO)₂, where X denotes an aliphatic hydrocarbon group with 4 to 12 carbon atoms, a cycloaliphatic or aromatic hydrocarbon group with 6 to 15 carbon atoms or an araliphatic hydrocarbon group with 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4-diisocyanatodiphenylmethane, 2,4-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomers, and mixtures containing these compounds.

Especially important mixtures of these isocyanates are the mixtures of the respective structural isomers of diisocyanatotoluene and diisocyanatodiphenylmethane. In particular, the mixture of 80 mol % of 2,4-diisocyanatotoluene and 20 mol % of 2,6-diisocyanatotoluene is suitable. Furthermore, the mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, the preferred mixing ratio of aliphatic to aromatic isocyanates ranging from 4:1 to 1:4. In a highly preferred embodiment, only isocyanates containing exclusively aliphatically bound NCO groups are used.

As polyisocyanates there can also be used isocyanates containing, besides free NCO groups, further groups derived from NCO groups, such as isocyanurate, biuret, urea, allophanate, uretdione or carbodiimide groups.

The described macrools, ionic or potentially ionic polyols as well as isocyanates and if necessary short-chain polyols are converted to an NCO-terminal prepolymer. For this purpose there are preferably used polyols containing difunctional structural units. According to the invention, the ratio of NCO groups to NCO-reactive groups must range between 1.1:1 and 2:1, preferably between 1.15:1 and 1.9:1, especially preferably between 1.2:1 and 1.5:1.

This prepolymer will be further reacted in step b. As reaction components there can be used all aliphatic and/or cycloaliphatic compounds that contain at least two amino groups that are reactive toward isocyanates. The use of diamine is preferred. Particularly suitable in this regard are ethylenediamine, propylenediamine, hexamethylenediamine, isophoronediamine (IPDA), p-xylylenediamine, 4,4-diaminodicyclohexylmethane and 4,4-diamino-3,3-dimethyldicyclohexylmethane.

The prepolymer is reacted with the said compounds, preferably in an NCO group/NH group ratio of 0.9:1 to 1:1. Particularly preferred according to the invention is a ratio of 0.95:1 to 1:1, and highly preferred is a ratio of 1:1. From this it follows that the NCO content after step b) ranges from 0 to a maximum of 0.2 wt % relative to the prepolymer.

The reaction of the prepolymer is followed by neutralization. Suitable for this purpose are, for example, ammonia, N-methylmorpholine, dimethylisopropanolamine, triethylamine, dimethylethanolamine, methydiethanolamine, triethanolamine, morpholine, tripropylamine, ethanolamine, diethanolamine, triisopropanolamine, N-ethyldiisopropylamine and mixtures thereof.

Especially preferred according to the invention is the use of ammonia. According to the invention, the content of COO^{—} NH₄^{—} after neutralization should range between 100 and 600 mmol/kg, preferably between 200 and 500, and particularly preferably between 250 and 500.

After neutralization, the product is dispersed with water and solvent is distilled off if necessary. By the addition of water and subsequent removal of the solvent by distillation, it is possible in particular to adjust the desired concentration of solids.

The polyurea-polyurethane dispersions used according to the invention can also be mixed with further substances. Preferably the aqueous dispersions contain 10 to 65, more preferably 15 to 50 wt % of the polyurethane.

Additional substances used to control the release of the fertilizers can be added to the dispersions. These are mainly substances such as lignin, starch and cellulose. Their contents generally range from approximately 0.1 to approximately 5 wt %, preferably from approximately 0.1 to 3 wt % relative to the total quantity of coating substance.

Furthermore, the polyurea-polyurethane dispersions used according to the invention can also contain hydrophobic adjuvants, other dispersions or other adjuvants. Particularly suitable for this purpose are the substances described on page 5, line 64 to page 7, line 8 of German Patent 19625453 A1. According to the invention, however, the polyurea-polyurethane dispersions are preferably used without addition of further polymer dispersions.

The inventive polyurea-polyurethane dispersions can also contain trace elements. Particularly suitable for this purpose are the elements described on page 2, line 34 to line 36 of European Patent 380193 A2.

Furthermore, the polyurea-polyurethane dispersions used according to the invention can also contain active ingredients. For this purpose those described on page 3, lines 17 to 39 of European Patent 389193 A2 are preferred.

According to the invention, one or more layers can be applied on the agent. In an alternative version of the invention, at least one inner layer and one outer layer are applied on the agent, the outer layer preferably being prepared from a dispersion containing the described polyurea-polyurethane. In an alternative version of the invention, it is possible in principle to use as the inner layer or layers all substances that are usable for coatings of fertilizers and that are different from the polyurea-polyurethane dispersion used according to the invention. Preferably the inner layer also contains at least one biodegradable substance, which is different, however, from the polyurea-polyurethane dispersion used in the outer layer.

The dispersions are expediently applied by spraying. The dispersions used according to the invention are suitable for coating operations at elevated process temperatures. The substantially higher water vapor pressures at higher temperatures greatly increase the capacity of a coating plant. Coating mainly takes place at a temperature of 10 to 110° C., preferably 30 to 70° C.

To ensure that the inventive agent is not leached out during application of the aqueous dispersion, only a limited volume of the dispersions is applied per time unit and care is taken that the water can evaporate rapidly.

This is expediently achieved by spraying with the dispersions, at a temperature of 10 to 110° C., preferably 30 to 70° C., a fluidized bed generated by fluidizing the starting fertilizer granules with a fluidizing gas. After the solutions or dispersions have been sprayed on, the fluidized bed is maintained until the dispersing medium has evaporated.

Such fluidized-bed application methods are generally known and, for the production of coated fertilizer granules, are described in U.S. Pat. No. 5,211,985. With this method it is possible to produce particularly uniform and thin coatings, which generally have a thickness of approximately 10 to approximately 150 μm, preferably approximately 10 to approximately 100 and especially approximately 20 to approximately 80 μm

In order to additionally reduce the agglutination and caking tendency of the coated agents, powdered solids such as talc, Sio₂, Al₂O₃ or TiO are advantageously applied if necessary following the coating process.

The agents coated according to the invention, together with nitrification inhibitors or growth regulators if necessary, are spread by standard methods on the soil, where they release the nutrients over a relatively long period. The agents are characterized in particular by the fact that they have relatively little agglutination and caking tendency, even at elevated temperature, and their coating envelopes are insensitive to mechanical stresses and strains such as typically encountered during transfer from one container to another, transportation or application.

### BRIEF DESCRIPTION OF THE DRAWINGS

Other objects and features of the present invention will become apparent from the following detailed description considered in connection with the accompanying drawing which discloses several embodiments of the present invention. It should be understood, however, that the drawing is designed for the purpose of illustration only and not as a definition of the limits of the invention.

In the drawing, the FIGURE shows the yield of Chinese cabbage over 3 crops with various coated fertilizers.

### DETAILED DESCRIPTION OF PREFERRED EMBODIMENTS

Turning now in detail to the drawing, the FIGURE shows the present invention will be explained hereinafter on the basis of some examples:

### EXAMPLE 1

### Synthesis of a Polyurea-Polyurethane Dispersion

In a stirring flask there are placed:

800 g (0.4 mol) of a polyester polyol of isophthalic acid, adipic acid and hexane-1,6-diol with OH number of 56 mg/g,

80.4 g (0.60 mol) of DMPA and

36.0 g (0.40 mol) of butane-1,4-diol.

To this there are added at 105° C.

400 g (1.80 mol) of IPDI and

160 g of acetone.

After four hours of stirring at 105° C., the mixture is diluted with

1600 g of acetone.

The NCO content of the solution is determined as 1.11% (calculated: 1.08%).

The solution is cooled to 45° C. and mixed with

68.0 g (0.40 mol) of IPDA.

After 90 minutes,

50.0 g (0.73 mol) of 25% aqueous ammonia is added for neutralization and

3000 g of water is added for dispersion, and the acetone is drawn off under vacuum.

### EXAMPLE 2

### Properties of the Coating Materials

The properties of the coating materials can be reproduced in model experiments. Thus it is possible to cast films of defined thickness from the aqueous dispersion of the coating materials, to dry off the water and to obtain a film. This film can be examined for mechanical characteristics. Compared with the prior art, the inventive materials of biodegradable polyurea-polyurethane exhibit a substantial improvement in terms of the characteristics of tearing strength, elasticity and stability during storage in water. This is illustrated in Table 1.

Table 1: Tearing Strength of Films of 50 μm Thickness

Comparison material per European Patent 0931036: 4.8 MPa

Inventive polyurethane: 12 MPa

Elasticity upon Elongation

Comparison material per European Patent 931036: 70%

Inventive polyurethane: 120%

Deliquescence during Storage in Water (Swelling of a Film)

Comparison material per European Patent 931036: 240%

Inventive polyurethane: 0%

### EXAMPLE 3

### Production of Coated Fertilizer Granules

In a commercial fluidized-bed coater, the granules of Nitrophoska® Perfekt fertilizer (15+5+20+2) used as starting material were fluidized with preheated air and heated to the desired temperature. Aqueous polyurea-polyurethane dispersions were atomized through appropriate nozzles and thereby the starting fertilizer granules were enveloped with a coating of polyurea-polyurethane. The spraying rate was adjusted such that leaching of the fertilizer was prevented. After completion of spraying, the coated fertilizer granules obtained were dried for several additional minutes in the fluidized bed. There were obtained coated fertilizer granules that were readily processable and that did not exhibit stickiness at ambient temperature.

### EXAMPLE 4

### Properties of the Coated Granules

a) Nutrient Release under Laboratory Conditions

To characterize the nutrient release, the coated fertilizer granules were subjected to an intensive leaching test. For this purpose a sample of the coated fertilizer granules (50 g) to be tested was placed in a U-shaped glass vessel, which was then rinsed with a uniform flow of 1500 ml of distilled water per day at 20° C. The collected rinse liquid was tested for its nutrient content (usually only nitrogen). The result was divided by the quantity of nutrient present in the starting fertilizer granules and expressed in percent. The results of the tests performed over several days are presented together with some comparison values in the table.

TABLE
Nitrogen release from coated fertilizers in the
laboratory test

| | | 4% | | 6% |
|---|---|---|---|---|
| | 4% | comparison | 6% | comparison |
| | inventive | material per | inventive | material per |
| | polyurethane | EP 931036 | polyurethane | EP 931036 |
| 1st day | 15.4% | 50.6% | 2.1% | 4.6% |
| 2nd day | 29.4% | 55.2% | 3.9% | 8.6% |
| 3rd day | 41.1% | 57.9% | 5.3% | 14.7% |
| 4th day | 51.1% | 59.9% | 6.8% | 22.1% |
| 5th day | 58.4% | 61.6% | 9.1% | 28.3% |
| 6th day | 63.9% | 63.7% | 11.8% | 34.7% |
| 7th day | 68.8% | 66.0% | 14.4% | 39.2% |

b) Slow-Release Effect in the Plant Cultivation Test

Coated fertilizers should ensure a long-time effect and slow release of the nutrients. In the plant test, it can be demonstrated how slow release takes place as a function of the quantity of coating applied. This long-time effect can be demonstrated, for example, by fertilizing vegetables such as Chinese cabbage at the start of cultivation and then allowing them to grow. At the end of the growth period they are cut off and the fresh weight is measured. Low fresh weight corresponds to slower release of the fertilizer used. Since the long-time effect of well coated fertilizers is longer than the cultivation time of Chinese cabbage, a second plant is started in the same vessel, without refertilization, after the first plant has been harvested. This second plant can also grow with the remaining fertilizers. This procedure can be repeated up to four times. Thereby the release characteristic is tested over a period that can correspond to a very long cultivation time. From the FIGURE it is evident that slow release similar to that when 6% of a comparison material per European Patent 931036 is used for coating (column 2) can be achieved by using, for coating, 3% of coating material (column 3) based on the polyurea-polyurethane to be used according to the invention. With 6% of the inventive coating material (column 1), the release is much slower than in the case of the comparison material. Compared with the prior art, therefore, the use of the new coating material represents a substantial advance.

FIGURE legend (Yield of Chinese cabbage over 3 crops with various coated fertilizers):

the Y axis represents the fresh weight in g per cabbage head on a scale of 0 to 300

Nitrophoska is the carrier fertilizer in all cases

half-dark region of column: 1st crop

dark region of column: 2nd crop

light region of column: 3rd crop

c) Agglutination Tendency of the Fertilizers

Coated fertilizers according to European Patent 931036 are very sticky at the surface. The unprotected coated product cannot be stored at room temperature. In the fertilizer art, this caking tendency is determined qualitatively by a caking test. For this purpose a sample of 100 g of fertilizer is compacted by centrifuging for 24 hours in a cylindrical vessel of 5 cm diameter. The force necessary to shear off the resulting cylinder once again is then measured. The necessary knock-out force is 400 Newtons for fertilizers coated according to European Patent 931036 and about 40 Newtons for fertilizers coated according to the invention. These numbers show that storage of the comparison material without anticaking agents is not possible. It is entirely possible, however, for the fertilizers coated with the inventive polyurea-polyurethane.

Accordingly, while a few embodiments of the present invention have been shown and described, it is to be understood that many changes and modifications may be made thereunto without departing from the spirit and scope of the invention as defined in the appended claims.

What is claimed is:

1. A method for the production of solid agents that contain active ingredients for plants comprising
coating solid agents with at least one biodegradable polymer layer; and
forming said polymer layer by applying dispersions containing polymers carrying urethane and urea groups onto the solid agents.

2. A method according to claim 1, wherein aqueous dispersions are used.

3. A method according to claim 2, wherein the dispersions used contain 20 wt % to 90 wt % of water and 10 wt % to 80 wt % of polymers carrying urethane and urea groups, wherein the percent by weight is based upon the total weight of the dispersion.

4. A method according to claim 1, wherein the polymers used are based on polyester polyols and isocyanates.

5. A method according to claim 4, wherein the polymers used are based on aliphatic isocyanates.

6. A method according to claim 2, wherein anionic polymer dispersions are used.

7. A method according to claim 1, wherein the polymer dispersions used are obtained by
a) synthesizing an NCO-terminal prepolymer from macrools, ionic or potentially ionic polyols and excess polyisocyanates,
b) reacting this prepolymer with compounds having at least 2 amino groups that are reactive toward isocyanate, in a ratio of NCO groups/NH groups of ≦1:1, and
c) neutralizing.

8. A method according to claim 7, wherein short-chain polyols are additionally used in step a).

9. A method according to claim 7, wherein 2,2-di-(hydroxymethyl)-alkanemonocarboxylic acids are used as the ionic or potentially ionic polyols.

10. A method according to claim 7, wherein di-(hydroxymethyl)propionic acid is used as the ionic or potentially ionic polyol.

11. A method according to claim 7, wherein diamines are used for the reaction with the prepolymer.

12. A method according to claim 7, wherein the NCO/NH functional ratio in the prepolymer ranges between 0.9:1 and 1:1.

13. A method according to one of claim 7, wherein the NCO/NH functional ratio ranges between 0.95:1 and 1:1.

14. A method according to claim 7, wherein ammonia is used for neutralization.

15. A method according to claim 7, wherein there are polymer dispersions used that contain further dispersions, adjuvants, active ingredients, trace elements or mixtures of these substances.

16. A solid agent that contains nutrients for plants, that has a biodegradable coating and that is produced in a method according to claim 1.

17. An agent according to claim 16, comprising granules.

18. An agent according to claim 17, wherein the mean diameter of the granules ranges from 0.5 to 10 mm.

19. An agent according to claim 18, wherein the mean diameter ranges from approximately 0.7 to 5 mm.

20. An agent according to claim 17, wherein the mean bulk density of the granules ranges between 0.5 and 1.5 kg per liter.

21. A fertilizer comprising an agent according to claim 17.
